(19) United States
(12) Patent Application Publication
(10) Pub. No.: US 2008/0134913 A1
(43) Pub. Date: Jun. 12, 2008

(54) STENCIL PRINTING APPARATUS

(75) Inventor: Mitsuo Sato, Miyagi (JP)

Correspondence Address: OBLON, SPIVAK, MCCLELLAND MAIER & NEUSTADT, P.C., 1940 DUKE STREET, ALEXANDRIA, VA, 22314, US

(73) Assignee: Tohoku Ricoh Co., Ltd., Shibata-gun (JP)

(21) Appl. No.: 11/849,762

(22) Filed: Sep. 4, 2007

(30) Foreign Application Priority Data
Dec. 12, 2006 (JP) 2006-334987

(51) Int. Cl. B41L 13/04

(52) U.S. Cl. 101/118

(57) ABSTRACT

A stencil printing apparatus allows printing on coated paper as in ordinary paper (uncoated paper), and can make a contribution to the diversification of printing needs. The stencil printing apparatus comprises a printing apparatus body comprising a printing drum having UV curable ink, and an UV irradiation device connected to a paper output unit of the printing apparatus body. When the paper type is recognized as coated paper on the basis of a signal from paper type input means or the like, control means controls a master-making energy supplied to a thermal head serving as master-making means, to be larger than a master-making energy supplied in the case of uncoated paper. The paper onto which an ink image corresponding to the characteristics of coated paper has been transferred is then fed into the UV irradiation device, where the ink is dried and cured.

### BACKGROUND OF THE INVENTION

1. Field of the Invention

The present invention relates to a stencil printing apparatus in which printing is carried out on the basis of image data of a document by closely wrapping a stencil paper (hereinafter sometimes referred to as “master”) on the outer face of a printing drum.

2. Description of the Related Art

Technologies relating to the present invention are also disclosed in, e.g., Japanese Patent No. 3691259 (Prior Art 1), Japanese Patent No. 3212052 (Prior Art 2), Japanese Unexamined Patent Application Laid-open No. S61-206673 (Prior Art 3), Japanese Unexamined Patent Application Laid-open No. 2004-284271 (Prior Art 4) and Japanese Unexamined Utility Model Application Laid-open No. H4-135369 (Prior Art 5).

Known stencil printing apparatuses include, for instance, stencil printing apparatuses comprising a master-making device for perforation master-making in which plural independent holes are perforated on a master by a thermal head; a tubular printing drum rotationally driven around its center axis, such that the perforated master is wrapped around the outer periphery of the printing drum; an ink supply device provided inside the printing drum, for supplying ink to the inner face of the printing drum; a paper feed device for separating and feeding printing paper; and a printing pressure device for pressing the fed printing paper against the outer peripheral face of the printing drum; wherein a print image is formed by transferring ink onto the printing paper through the perforated portion of the master.

In such a master-making device in a stencil printing apparatus, numerous independent holes are perforated through selective heating of a thermoplastic resin film of the master by small heating elements of a thermal head, on the basis of image information. The print image is formed through direct transfer of ink onto the printing paper surface, via the perforated portion of the master. Although the ink is transferred to the printing paper, thus, in the form of independent dots, the ink spreads then through seeping and penetration into the fibers of the paper surface, to form an image. Filling of solid portions is effected through this seeping/spreading.

The paper used in conventional stencil printing apparatuses had to possess ink permeability as a prerequisite, since drying in these apparatuses relied on ink permeation into the paper. Herein, pseudo-drying takes place through ink permeation in the fibers of the paper onto which the ink is transferred, and subsequent evaporation of the aqueous phase in the ink. Seeping and spreading on a paper surface are hence known features. In order to achieve higher fineness, though, seeping and spreading have been required hitherto to be kept to a minimum.

Variable control of the energy supplied to the heating elements of the thermal head is itself a known feature in conventional stencil printing apparatuses. For instance, Prior Art 1 discloses variable control of applied energy during master-making in such a way so as to reduce the diameter of perforated holes, for the pixels that form the outline of an image. Prior Art 2 discloses a master-making apparatus in which heating energy is controlled in accordance with ink type or original master type. Prior Art 3 discloses using a larger head supply energy in a stamp master-making mode than in a text mode.

Variable control of the printing pressure with which printing paper is pressed against a tubular printing drum, in accordance with ink type and/or master type, are also known features in conventional stencil printing apparatuses. Prior Art 4 discloses pressing force control for printing pressure adjustment in accordance with printing paper type and degree of energy saving. The pressing force is reduced herein with the goal of achieving energy-saving printing. Prior Art 5 discloses a stamping apparatus comprising pressing-force control means for controlling pressing force in accordance with the type of printing paper.

As explained above, images are formed in stencil printing apparatuses by ink seeping and spreading through the fibers on the paper surface. Coated papers, in which ink permeation is ineffective, could thus not be printed. As a result, coated paper, which affords a glossy high-quality feel, could not be used herein as printing paper.

As regards the problem of drying of the transferred ink, stencil printing becomes possible for coated paper if, for instance, the ink employed is modified into an UV curable ink that is cured, after printing, through irradiation of UV rays. In addition to the problem of drying and fixing, however, actual printing on coated paper involved also problems relating to print image formation by ink transfer. One such problem is that ink transferred to the paper surface remains thereon in the form of dots, without spreading, which precludes securing density in solid image portions. Such ink seeping and spreading does not occur in the case of coated paper.

### SUMMARY OF THE INVENTION

Thus, it is an object of the present invention to provide a stencil printing apparatus that allows printing on coated paper as in ordinary paper (uncoated paper), and that can make a contribution to the diversification of printing needs.

In an aspect of the present invention, a stencil printing apparatus comprises a master-making device for perforating a stencil master using master-making means; a tubular printing drum around which the perforated stencil master is attached and which is rotationally driven; a sheet feeding device for separating and feeding sheets for printing; a printing pressure device for pressing a fed sheet against the outer peripheral face of the printing drum; at least one among paper type input means for inputting a distinction of whether the sheets set in the sheet feeding device are coated paper or uncoated paper, and paper type detection means for detecting whether the sheets set in the sheet feeding device are coated paper or uncoated paper; and a control device for, when a fed sheet is recognized as coated paper, controlling a master-making energy supplied to the master-making means to be larger than that in the case of uncoated paper.

In another aspect of the present invention, a stencil printing apparatus comprises a master-making device for perforating a stencil master using master-making means; a tubular printing drum around which the perforated stencil master is attached and which is rotationally driven; a sheet feeding device for separating and feeding sheets for printing; a printing pressure device for pressing a fed sheet against the outer peripheral face of the printing drum; at least one among paper type input means for inputting a distinction of whether the sheets set in the sheet feeding device are coated paper or uncoated paper, and paper type detection means for detecting whether the sheets set in the sheet feeding device are coated paper or uncoated paper; a pressing force varying mechanism capable of varying a pressing force of the printing pressure device; and a control device for, when a fed sheet is recognized as coated paper, controlling the pressing force to be larger than that in the case of uncoated paper, using the pressing force varying mechanism.

In another aspect of the present invention, a stencil printing apparatus comprises a master-making device for perforating a stencil master using master-making means; a tubular printing drum around which the perforated stencil master is attached and which is rotationally driven; a sheet feeding device for separating and feeding sheets for printing; a printing pressure device for pressing a fed sheet against the outer peripheral face of the printing drum; at least one among paper type input means for inputting a distinction of whether the sheets set in the sheet feeding device are coated paper or uncoated paper, and paper type detection means for detecting whether the sheets set in the sheet feeding device are coated paper or uncoated paper; and a control device for, when a fed sheet is recognized as coated paper, controlling a master-making feeding pitch in the transport direction of the stencil master in the master-making device, to be larger than that in the case of uncoated paper.

In another aspect of the present invention, a stencil printing apparatus comprises a master-making device for perforating a stencil master using master-making means; a tubular printing drum around which the perforated stencil master is attached and which is rotationally driven; an ink supply device for supplying ink to an inner face of the printing drum; a sheet feeding device for separating and feeding sheets for printing; a printing pressure device for pressing a fed sheet against the outer peripheral face of the printing drum; at least one among paper type input means for inputting a distinction of whether the sheets set in the sheet feeding device are coated paper or uncoated paper, and paper type detection means for detecting whether the sheets set in the sheet feeding device are coated paper or uncoated paper; an ink heating device for heating ink of the ink supply device; and a control device for, when a fed sheet is recognized as coated paper, controlling the temperature of supplied ink to be larger than that in the case of uncoated paper using the ink heating device.

In another aspect of the present invention, a stencil printing apparatus comprises a master-making device for perforating a stencil master using master-making means; a tubular printing drum around which the perforated stencil master is attached and which is rotationally driven; a sheet feeding device for separating and feeding sheets for printing; a printing pressure device for pressing a fed sheet against the outer peripheral face of the printing drum; at least one among paper type input means for inputting a distinction of whether the sheets set in the sheet feeding device are coated paper or uncoated paper, and paper type detection means for detecting whether the sheets set in the sheet feeding device are coated paper or uncoated paper; a text and photograph separation device for separating image information into a text image portion and a photograph image portion; and a control device for, when a fed sheet is recognized as coated paper, variably controlling an energy applied to each heating element of the master-making means such that a master-making perforated diameter of pixels constituting a text image portion is made larger than a master-making perforated diameter of pixels constituting a photograph image portion.

In another aspect of the present invention, a stencil printing apparatus comprises a master-making device for perforating a stencil master using master-making means; a tubular printing drum around which the perforated stencil master is attached and which is rotationally driven; a sheet feeding device for separating and feeding sheets for printing; a printing pressure device for pressing a fed sheet against the outer peripheral face of the printing drum; and a control device for, when the sheet is coated paper, controlling a master-making energy supplied to the master-making means to be larger than that in the case of uncoated paper for which master-making energy data is determined beforehand.

In another aspect of the present invention, a stencil printing apparatus comprises a master-making device for perforating a stencil master using master-making means; a tubular printing drum around which the perforated stencil master is attached and which is rotationally driven; a sheet feeding device for separating and feeding sheets for printing; a printing pressure device for pressing a fed sheet against the outer peripheral face of the printing drum; a pressing force varying mechanism capable of varying a pressing force of the printing pressure device; and a control device for, when the sheet is coated paper, controlling the pressing force, using the pressing force varying mechanism, to be larger than that in the case of uncoated paper for which pressing force data is determined beforehand.

In another aspect of the present invention, a stencil printing apparatus comprises a master-making device for perforating a stencil master using master-making means; a tubular printing drum around which the perforated stencil master is attached and which is rotationally driven; a sheet feeding device for separating and feeding sheets for printing; a printing pressure device for pressing a fed sheet against the outer peripheral face of the printing drum; and a control device for, when the sheet is coated paper, controlling a master-making feeding pitch in the transport direction of the stencil master in the master-making device, to be larger than that in the case of uncoated paper for which master-making feeding pitch data is determined beforehand.

In another aspect of the present invention, a stencil printing apparatus comprises a master-making device for perforating a stencil master using master-making means; a tubular printing drum around which the perforated stencil master is attached and which is rotationally driven; an ink supply device for supplying ink to an inner face of the printing drum; a sheet feeding device for separating and feeding coated paper as sheets for printing; a printing pressure device for pressing a fed sheet against the outer peripheral face of the printing drum; an ink heating device for heating ink of the ink supply device; and a control device for controlling the temperature of supplied ink, using the ink heating device, to be larger than that in the case of uncoated paper for which temperature data for supplied ink is determined beforehand.

In another aspect of the present invention, a stencil printing apparatus comprises a master-making device for perforating a stencil master using master-making means; a tubular printing drum around which the perforated stencil master is attached and which is rotationally driven; a sheet feeding device for separating and feeding sheets for printing; a printing pressure device for pressing coated paper as a fed sheet onto the outer peripheral face of the printing drum; a text and photograph separation device for separating image information into a text image portion and a photograph image portion; and a control device for variably controlling an energy applied to each heating element of the master-making means such that a master-making perforated diameter of pixels constituting a text image portion is made larger than a master-making perforated diameter of pixels constituting a photograph image portion.

In another aspect of the present invention, a stencil printing apparatus comprises a master-making device for perforating a stencil master using master-making means; a tubular printing drum around which the perforated stencil master is attached and which is rotationally driven; an ink supply device for supplying ink to an inner face of the printing drum; a sheet feeding device for separating and feeding coated paper as sheets for printing; a printing pressure device for pressing a fed sheet against the outer peripheral face of said printing drum; an ink heating device for heating ink of the ink supply device. At least one value among a master-making energy supplied to the master-making means, a pressing force by the printing pressure device, a master-making feeding pitch of the stencil master, a master-making feeding speed of the stencil master, and a supply ink temperature, is set to a value determined beforehand based on characteristics of uncoated paper.

### BRIEF DESCRIPTION OF THE DRAWINGS

The above and other objects, features and advantages of the present invention will become more apparent from the following detailed description taken with the accompanying drawings in which:

FIG. 1 is a diagram illustrating a schematic constitution of a stencil printing apparatus according to a first embodiment of the present invention;

FIG. 2 is a cross-sectional diagram illustrating a schematic constitution of a printing drum of the stencil printing apparatus;

FIG. 3 is a plan-view diagram illustrating the constitution of a relevant portion of an operation panel;

FIG. 4 is block diagram illustrating the constitution of a control system;

FIG. 5 is a cross-sectional diagram illustrating a paper type detection sensor during use;

FIG. 6A is a schematic diagram illustrating paper surface reflectance in the case of coated paper; FIG. 6B is a schematic diagram illustrating paper surface reflectance in the case of uncoated paper;

FIG. 7A is a diagram illustrating a perforation pattern on a master corresponding to coated paper with increased perforation energy, according to a second embodiment of the present invention; FIG. 7B is a diagram illustrating a perforation pattern on a master corresponding to conventional uncoated paper;

FIG. 8 is an electron micrograph close-up of a photograph image when printed on uncoated paper;

FIG. 9 is an electron micrograph close-up of a photograph image when printed on coated paper;

FIG. 10 is a diagram illustrating a perforation pattern corresponding to coated paper, according to a fifth embodiment of the present invention;

FIG. 11 is a flowchart illustrating an example of the operation of a control system of the present invention;

FIG. 12 is a micrograph illustrating an ink transfer state on a solid image portion for stencil printing on coated paper using a conventional procedure; and

FIG. 13 is a micrograph illustrating an ink transfer state on a solid image portion for stencil printing on ordinary paper using a conventional procedure.

### DESCRIPTION OF THE PREFERRED EMBODIMENTS

Firstly, in a conventional stencil printing apparatus, printing on coated paper was difficult because, as explained above, ink does not seep and spread on coated paper. That is, the ink transferred onto the surface of the paper remains there in the form of dots that fail to spread, as a result of which density cannot be secured in solid image portions.

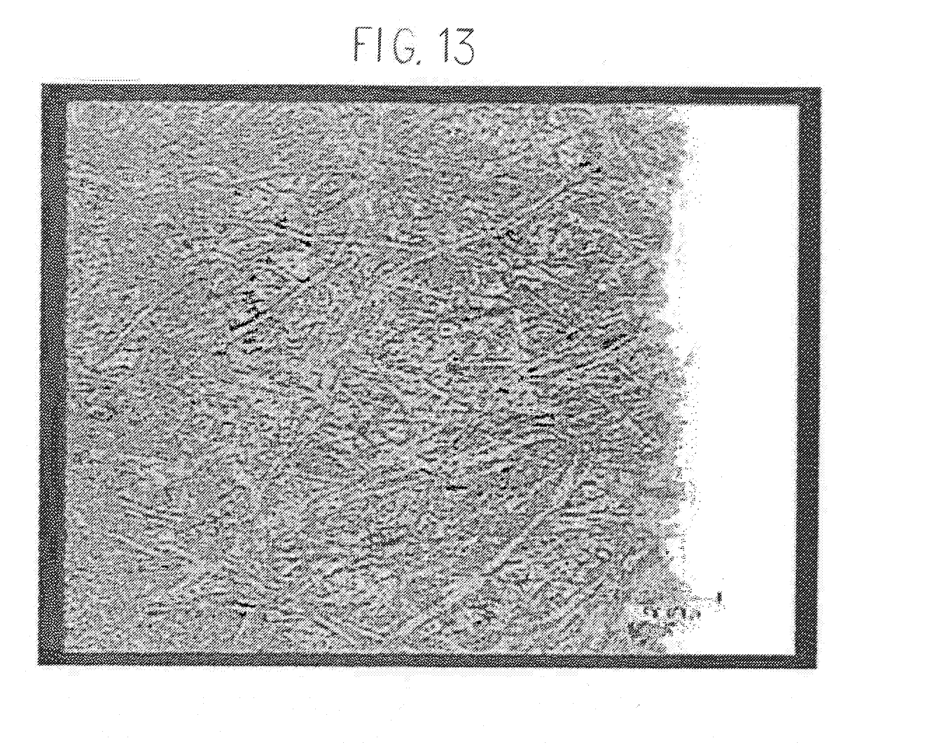

FIG. 12 is a micrograph illustrating the ink transfer state on a solid image portion of ink transferred to the surface of a coated paper by stencil printing. Black solid portions having insufficient density appear grey in the figure. For comparison, FIG. 13 illustrates a photograph of a solid-image ink transfer portion on conventional ordinary paper by stencil printing.

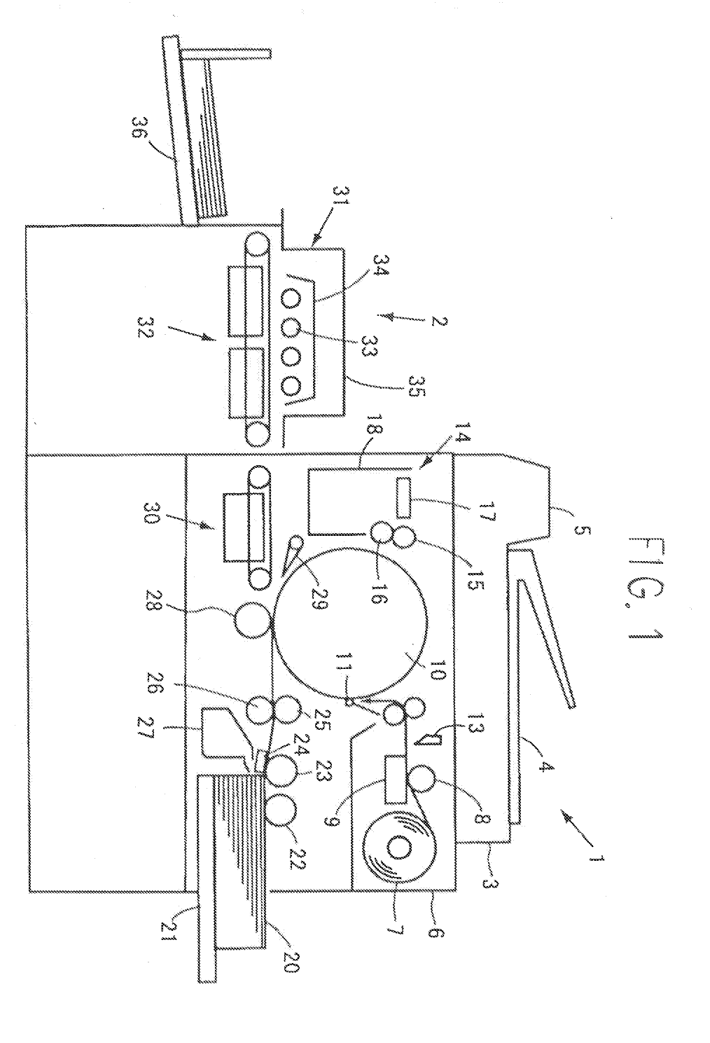

A first embodiment of the present invention is explained next with reference to FIGS. 1 to 6.

First, a summary of the overall constitution and of the printing operation of the stencil printing apparatus according to the present embodiment will be explained based on FIG. 1.

The stencil printing apparatus comprises a printing apparatus body 1 and an UV irradiation device 2, as an ink curing device, removably connected to a paper output unit of the printing apparatus body 1.

The reference numeral 3 denotes a scanner for reading a document image. On the scanner 3 there is provided an openable and closable pressure plate 4 and an ADF unit 5 for automatic sequential feeding of plural documents. The reference numeral 6 denotes a master-making apparatus having master-making and master-feeding functions. Herein a master 7 wound up in a roll shape is pressed against thermal head 9 serving as master-making means, by a platen roller 8, as a conveying means, whereby the master 7 is conveyed while being perforated.

The end of a master 12 after master-making is clamped by a master clamp 11 provided on the outer peripheral face of a printing drum 10, so that the master 12 after master-making is wrapped around the outer periphery of the printing drum 10 and is cut to a predetermined length by a cutter 13. The reference numeral 14 denotes a master ejection device for removing the used master from the outer periphery of the printing drum 10 and conveying and housing the master. The master ejection device 14 comprises master ejection rollers 15 and 16 for separating and conveying the master, a compression plate 17 for compressing the master, and a master ejection housing box 18 for housing the ejected master.

Printing paper 20 (coated paper) in the form of sheets is sequentially separated, sheet by sheet, from the top of a paper feed tray 21 by a separation roller 23 and a separation pad 24, while under a transport force exerted by a paper feed roller 22. The printing paper 20 is then fed into a printing unit (pressure contact portion between the printing drum 10 and the press roller 28) timed with a pair of resist rollers 25 and 26 downstream in the paper feed direction. For ensuring reliable separation of the coated paper during paper feeding, there is further provided an air jet device 27 for assisting separation by jetting air onto the paper from the front of the paper feed direction as well as from the sides.

A paper feeding device, in the form of a sheet feeding device, comprises for instance the paper feed tray 21, the paper feed roller 22, the separation roller 23, the separation pad 24 and air jet device 27.

The reference numeral 28 denotes a press roller as an element in a printing pressure device for carrying out image forming by pressing printing paper against the printing drum 10. The pressing operation of the press roller 28 is controlled by a separate drive source. The reference numeral 29 denotes a separation pawl for separating printing paper from the printing drum 10. The reference numeral 30 denotes a transport belt device for suctioning and transporting the paper printed by the printing drum 10. The printing paper on which there is formed an image through transfer of an ink image from the printing drum 10 is transported towards the UV irradiation device 2 that is connected to the transport belt device 30 downstream in the paper transport direction.

The printing ink supplied into the printing drum 10 is an UV curable ink. The UV irradiation device 2, which comprises an UV irradiation unit 31 and a printed product transport unit 32, is mechanically connected to the paper output side of the printing apparatus body 1.

The UV irradiation unit 31 is provided above the printed matter transport unit 32, and comprises UV lamps 33 such as high-pressure mercury lamps or metal halide lamps, a reflecting plate 34 formed of aluminum plate or the like, and a cover casing 35 provided outside the reflecting plate 34. Although not shown in the figure, there are also provided an air exhaust pipe, a suction fan and the like for suctioning air of the cover casing 35 and discharging it, through an ozone filter, out of the printing apparatus. The fixed printed product is discharged and loaded onto a paper output tray 36.

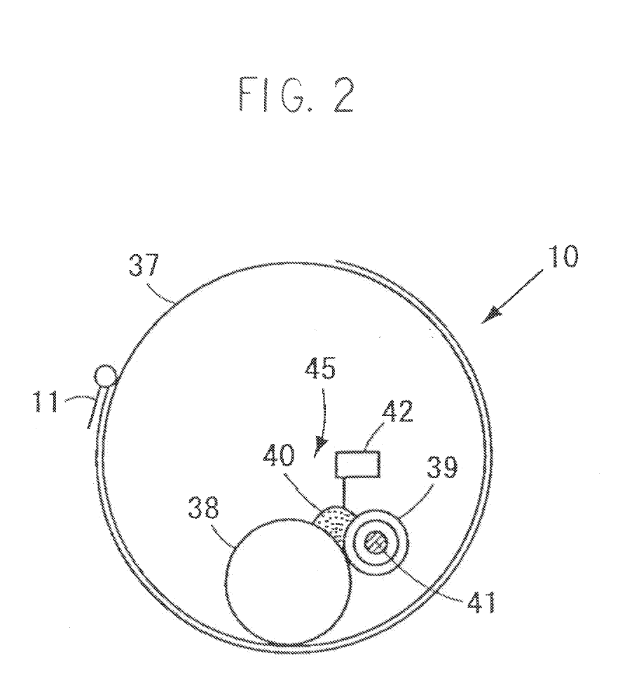

FIG. 2 illustrates the schematic constitution of the printing drum 10 in the above stencil printing apparatus. An ink supply device 45 is arranged inside a tubular drum body 37. In the ink supply device 45 there are formed an ink supply roller 38 and a doctor roller 39, leaving a gap in between where the two rollers form an ink pool 40.

The reference numeral 41 denotes a heating heater, as an ink heating means, provided inside the hollow doctor roller 39. When current passes through the heating heater 41, the temperature of the doctor roller 39 rises, whereby the temperature of the ink in the ink pool 40 can be raised. This temperature is controlled by control means 60 described below. The reference numeral 42 denotes a thermistor (temperature sensor) as an ink temperature detection means for detecting the temperature of the ink in the ink pool 40.

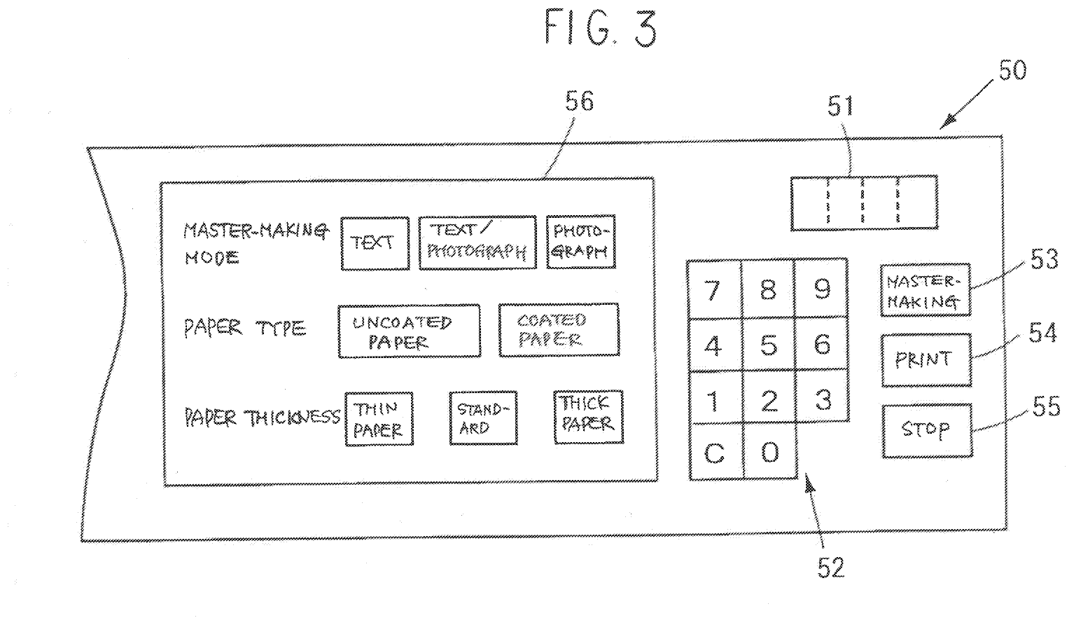

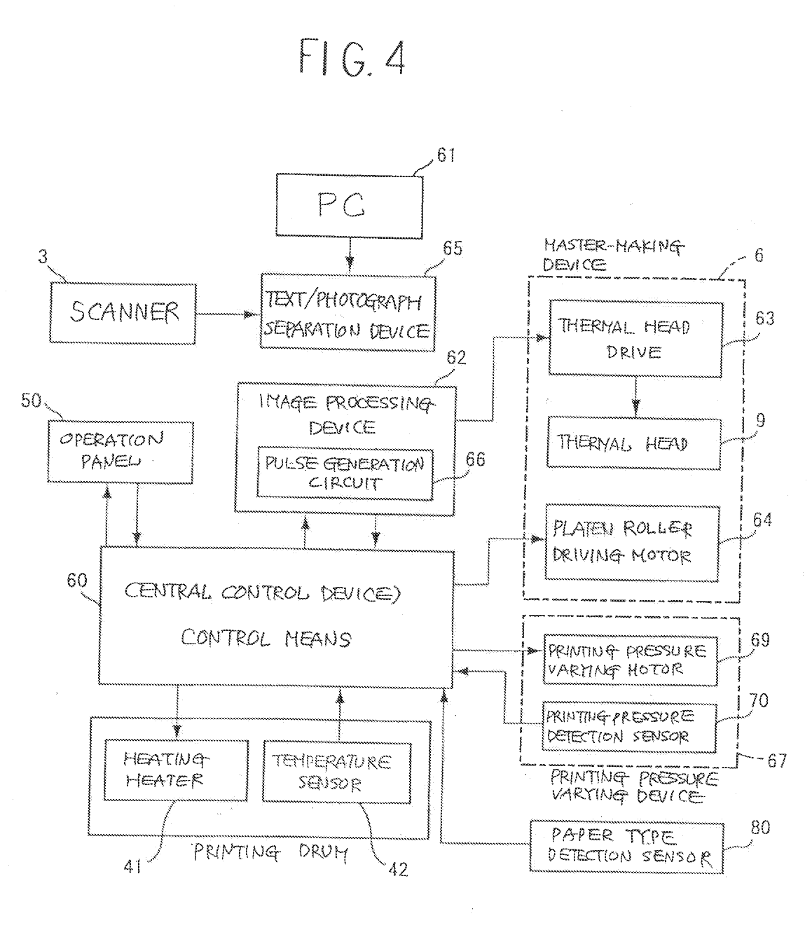

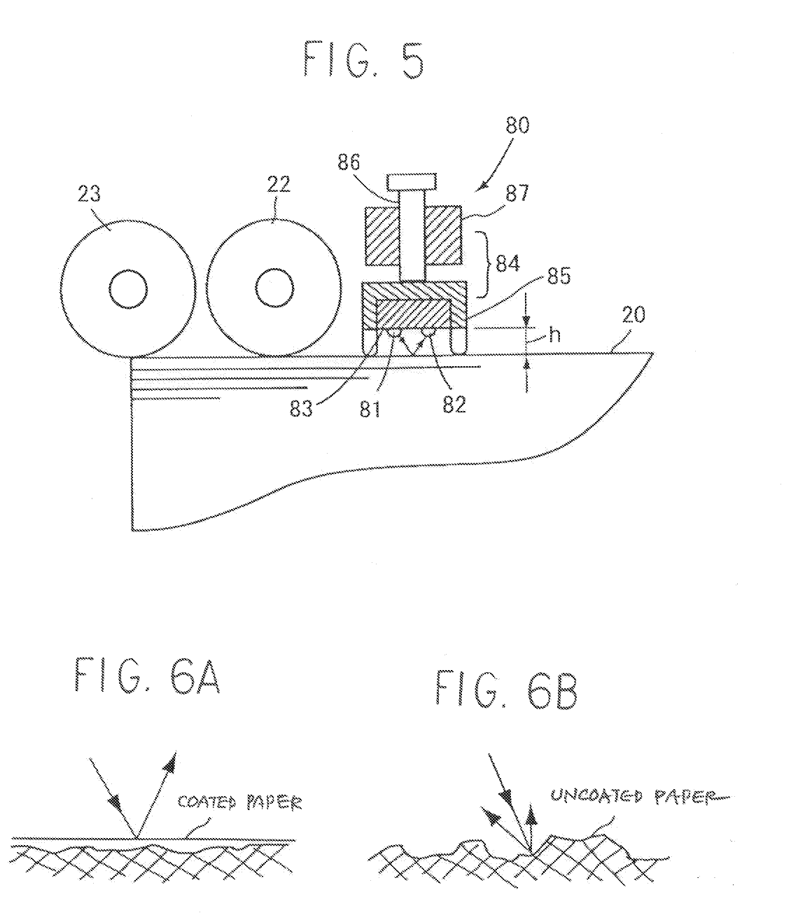

FIG. 3 illustrates part of an operation panel in the stencil printing apparatus. An operation panel 50 comprises, for instance, a printing setting sheet count display unit 51, an input numerical keypad 52, a master-making start key 53, a print start key 54, a stop key 55 and a liquid crystal display unit 56. The liquid crystal display unit 56 comprises touch keys that, when pressed on a portion corresponding to a respective display, allow inputting instructions. During standard operation, the initial display prompts, as illustrated in the figure, the instruction of a master-making mode and of paper type.

The master-making mode is instructed by selecting, for instance, a “text mode”, a “text/photograph mixed mode”, or a “photograph mode”. The type of paper is instructed by inputting first “coated paper” or “uncoated paper”, and selecting then “standard paper”, “thin paper” or “thick paper”.

The stencil printing apparatus of the present invention allows fixing an image by UV irradiation using an UV curable ink, and hence “coated paper” can be also used as the printing paper, in addition to conventional “uncoated paper”.

There is, however, a substantial difference between “coated paper” and “uncoated paper”, as the paper type, when it comes to forming a print image, and hence it is necessary to optimally control the master-making conditions and the printing conditions, which underlies the input instruction of paper type.

A paper type detection sensor 80 (FIG. 4), as paper type detection means, is further provided in the paper feeding device for detecting whether the paper is coated paper or not, based on light reflectance differences from the paper when the uppermost face of printing paper set in the paper feed tray 21 is illuminated with light. Coated paper can be automatically detected thereby. Thus, if the operator forgets to indicate “coated paper” in the operation panel 50, the below-described master-making conditions and the like of the coated paper are set up automatically. Of course, the operation panel 50 may comprise either manual instruction or automatic detection alone.

FIG. 4 illustrates the constitution of a control system in the stencil printing apparatus. The reference numeral 60 denotes control means of the stencil printing apparatus. Document image data information sent from a scanner 3 or a PC 61 is inputted into an image processing unit 62 where various image processes are carried out, whereupon a digital image signal resulting from image processing is sent to a thermal head drive 63. The thermal head drive 63 perforates thermally a master resin film, based on image information, by selectively driving heating elements of the thermal head 9 to emit heat. At the same time, the control means 60 controls the perforation speed in the transport direction by controlling the driving of a pulse motor 64, which drives the platen roller 8 that in turn transports and drives the master. This affords optimal perforation of the master 7.

In conventional technology, a larger master-making perforation diameter in a stencil printing apparatus entails, to a certain extent, a larger amount of ink transferred to the printing paper.

In a text/photograph separation device 65, each pixel that makes up an image of the document image data information sent from the scanner 3 or the PC 61 is identified and separated as being either a pixel constituting a text portion or a pixel constituting a photograph portion, then the document image data information is forwarded to the image processing unit 62. The image processing unit 62 has a pulse generator circuit 66 for deciding a heating pulse of the thermal head 9, whereby the image processing unit 62 can output a first output pulse in case of a text image portion, and a second output pulse in case of a photograph image, by varying the values of the outputs.

When “coated paper” is selected in the operation panel 50 as the paper type, or when coated paper is detected automatically by the paper type detection sensor 80, i.e. when the control means 60 recognizes (judges) “coated paper” based on a signal from the operation panel 50 or from the paper type detection sensor 80 (hereinafter, “when coated paper is recognized” for short), the first output pulse for the case of text image portion is set so that a voltage application time to the thermal head 9 is larger than the second output pulse for the case of a photograph image. For instance, the first output pulse is set to be 1.2 to 1.5 times the second output pulse.

In a memory, not shown if the figure, of the control means 60, there are stored various pre-set master-making conditions data of uncoated paper (similarly in other embodiments below), so that the first output pulse for text image portions is calculated on the basis of the output pulse for a photograph image, which is one of these pre-set master-making conditions data.

Dot master-making is carried out with appropriate energy for photograph image portions, thus affording images having high grayscale reproducibility, and affording also high-density images through master-making in which the perforation diameter is larger in text image portions on account of higher master-making energy.

An increase in the pulse width in the thermal head 9 entails a longer voltage application time, while the heating element takes also time to cool down. Accordingly, it becomes necessary to slow down somewhat the feeding speed of the master. Although the time required by master-making for achieving reliable image formation is slightly longer thus during coated paper printing, such slightly longer master-making time is not overly problematic, when taking into account the effect afforded thereby, of allowing realizing stencil printing on coated paper.

The constitution and operation of the paper type detection sensor 80 will be explained next with reference to FIG. 5 and FIGS. 6A and 6B.

As illustrated in FIG. 5, the paper type detection sensor 80 comprises a detection unit 83 having a light-emitting element 81 and a light-receiving element 82 formed integrally therewith, and a support 84 for keeping substantially constant the distance between the top face of the printing paper 20 and the detection unit 83, in a state that enables paper feeding.

The support 84 comprises a holder 85 having a tubular or C-shaped cross section, and which encapsulates the detection unit 83, a slide shaft 86 fixed on the top face of the holder 85 and extending in the up-and-down direction, and a fixedly positioned slide guide 87 for guiding the slide shaft 86. The slide shaft 86, freely guided in the up-and-down direction by the slide guide 87, drops on account of its own weight.

When the paper 20 is set on the paper feed tray 21 and the master-making start key 53 is pushed, the paper feed tray 21 rises and stops at a predetermined position detected by an upper position detection sensor not shown in the figure. At that position, the paper type detection sensor 80 detects the reflectance from the uppermost surface of the paper, to identify thereby whether the paper is coated paper or uncoated paper.

Upon rising of the paper feed tray 21, the uppermost face of the paper abuts a foot 85a of the holder 85, whereby a gap h between the detection unit 83 and the paper surface is accurately maintained at all times. The light-receiving element 82 detects light from the light-emitting element 81 that is reflected by the paper surface. Based on that signal, the control means 60 recognizes (judges) that the paper is coated paper when reflectance (including converted values to voltage or the like) is equal to or greater than a predetermined threshold value, and recognizes uncoated paper when the reflectance is smaller than the predetermined threshold value.

As illustrated in FIG. 6A, the surface of coated paper is extremely smooth and has high reflectance since the paper fibers are coated with a white material. On the other hand, as illustrated in FIG. 6B, the surface of uncoated paper (ordinary paper) comprises fibers that give rise to large irregularities, which in turn reflect light diffusedly, thus lowering reflectance.

As a method for discriminating whether paper is coated paper or uncoated paper there can be used also other known methods, for instance a surface roughness detection method.

A second embodiment of the present invention is explained next. Herein, portions identical to the above embodiment are denoted with identical reference numerals, and only relevant portions will be explained, omitting, unless specifically necessary, the explanation of already-described constitutions and functions (the same applies to other embodiments).

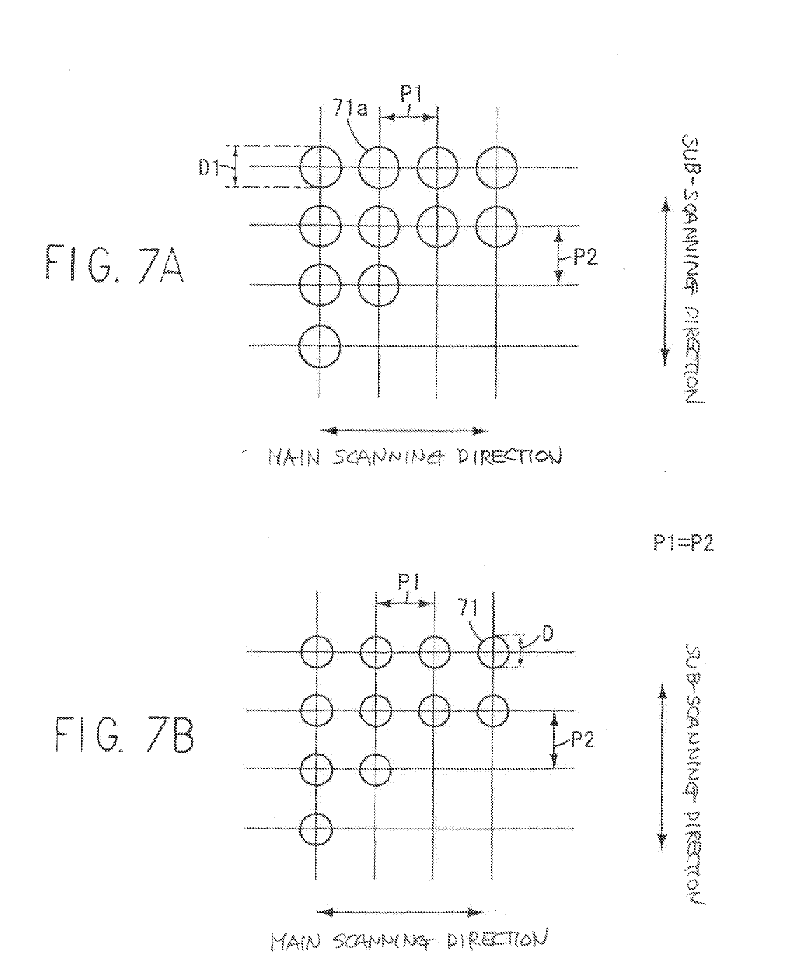

FIG. 7A illustrates a perforation pattern on a master film by the stencil printing apparatus of the present invention.

As illustrated in FIG. 7B, numerous independent holes 71 are ordinarily formed over the entirety of a perforated master film. The size (diameter D) of these perforated holes 71 is about 50 to 60% relative to the hole pitch P (main scanning direction pitch P1=sub-scanning direction pitch P2). In the case of uncoated paper, ink seeps and permeates along the fibers of the paper, spreading in the horizontal direction over the surface of the paper, providing thereby sufficient ink filling and affording thus the required image density.

In the case of coated paper, however, the fibers are absent in the surface of the paper, which has formed thereon a coat layer that prevents seeping, and hence the ink cannot spread in the horizontal direction. This is problematic in that, a result, sufficient ink filling cannot be achieved, and thus a required sufficient image density cannot be achieved, either.

In the present embodiment, therefore, when “coated paper” is recognized in the master-making device 6 the master-making energy for perforation is made larger than that for uncoated paper, to afford a larger hole diameter, thereby increasing the amount of ink transferred to the printing paper and enhancing the filling of solid images. The master-making energy for uncoated paper is determined beforehand and is stored in a memory not shown in the figure. Specifically, the size of the perforated holes 71a (diameter D1) is set to be about 70 to 80% of the hole pitch P.

A third embodiment of the present invention is explained next.

As illustrated in FIG. 4, the stencil printing apparatus of the present invention comprises a printing pressure varying device 67 for varying the pressing force of the press roller 28 that carries out image formation by pressing printing paper against the printing drum 10. The printing pressure varying device 67, in which a predetermined pressing force can be set, comprises a pulse motor 69 for varying the tension of a printing pressure spring, not shown, that presses the press roller 28 against the printing drum 10, and comprises also a sensor, not shown, for detecting the tension position of the above printing pressure spring.

In conventional technology, a larger printing pressure in a stencil printing apparatus implies, to a certain extent, a larger amount of ink transferred to the printing paper.

In the present embodiment, when the paper type is recognized as “coated paper”, the printing pressure (pressing force of the press roller) for forming a print image in the printing apparatus is made larger than that for uncoated paper, thereby increasing the amount of ink transferred to the printing paper and enhancing thus solid image filling. The pressing force for uncoated paper (ordinary printing pressing force) is determined beforehand and stored in the memory not shown.

Specifically, the pressing force is set to 1.2 to 1.5 times an ordinary printing pressing force.

The variable pressing force control of the present embodiment and the master-making energy control for text/photograph separation in the first embodiment may also be carried out simultaneously.

A fourth embodiment of the present invention is explained next.

Extraordinarily high-quality printing of photograph images can be achieved, for stencil print images on coated paper, by carrying out ink transfer on individual dots while suppressing ink seeping and/or horizontal spread. In solid image portions and/or text image portions, however, solid filling is insufficient and there are obtained images having insufficient density and/or fragmented text. In the present embodiment, therefore, the master-making device 6 or the printing pressure device is optimally controlled so as to enhance solid filling during “text mode” printing, while during “photograph mode”, the master-making device 6 or the printing pressure device is optimally controlled so as to reduce seeping at independent dots.

In a text mode, thus, the first output pulse is selected, and the voltage application time in the thermal head 9 is set so as to be larger than the second output pulse for the photograph mode. Herein, the first output pulse is set to be 1.2 to 1.5 times the second output pulse.

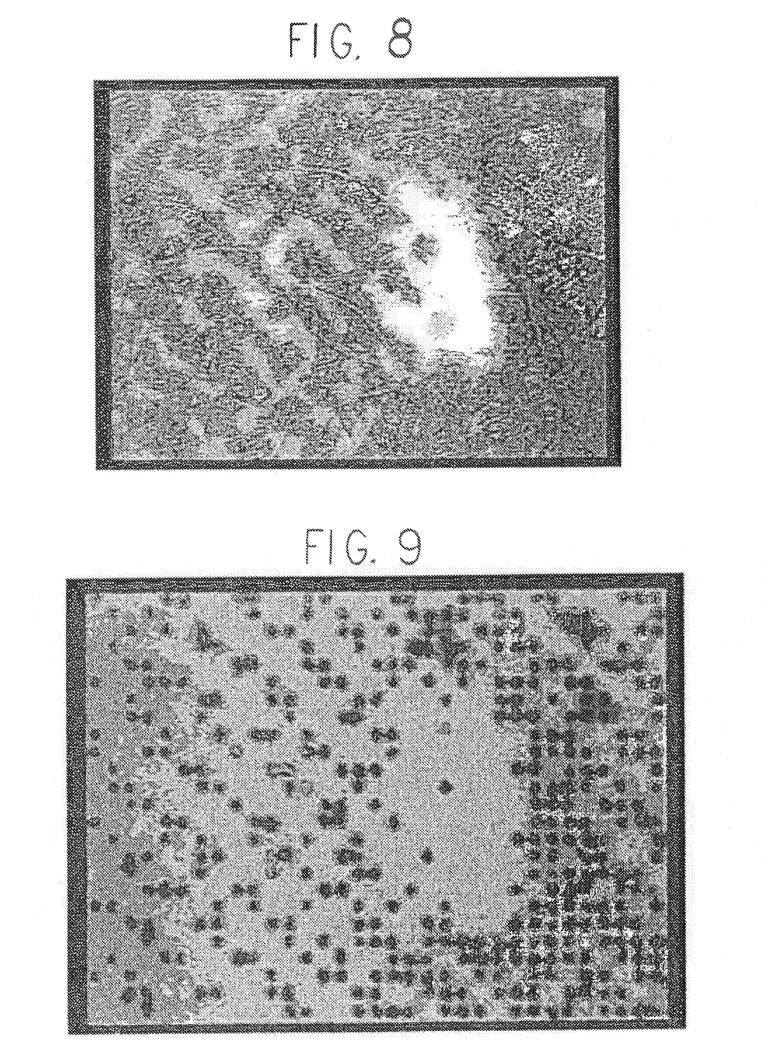

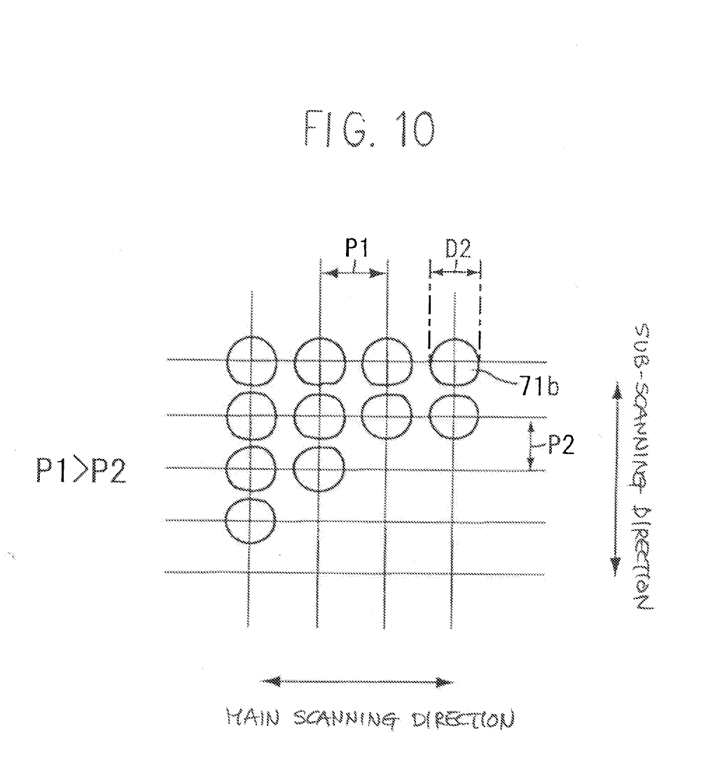

FIG. 8 is an electron micrograph close-up of a photograph image of a specific portion printed on conventional uncoated paper, where image breaking occurs on account of ink seeping and/or spreading, thereby precluding achieving a photograph image of high quality. FIG. 9 is an electron micrograph close-up of the photograph image of the same specific portion printed in conventional coated paper. In this case the image does not break and a photograph image of high quality can be obtained.

A fifth embodiment of the present invention is explained next.

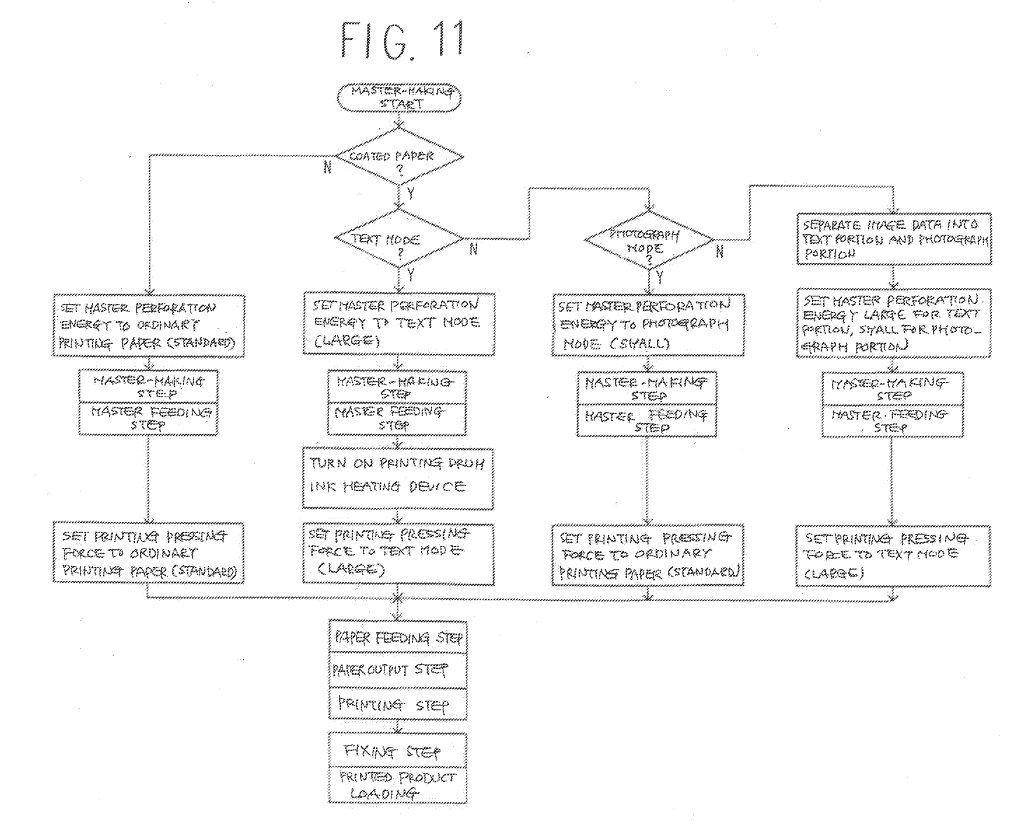

FIG. 10 illustrates a pattern perforated on a master film by the master-making device 6. As illustrated in FIG. 7B, numerous independent holes 71 are formed over the entirety of an ordinary perforated master film. The direction perpendicular to the master transport direction (main scanning direction) is the longitudinal direction of a line-type thermal head. The heating element pitch in this direction is determined by the thermal head and cannot be modified.

The pitch in the master transport direction (sub-scanning direction) is determined by the thermal head and hence can be modified. Ordinarily, the main scanning direction pitch and the sub-scanning direction pitch are controlled so as to be identical.

In case of master-making for printing on uncoated paper in the present embodiment, perforation is controlled, as described above, so as to render equal the main scanning direction pitch P1 and the sub-scanning direction pitch P2, but in case of master-making for printing on coated paper, perforation is controlled so as to render the sub-scanning direction pitch P2 smaller than the main scanning direction pitch P1.

Controlling the sub-scanning direction pitch P2 so as to make it smaller than the main scanning direction pitch P1 allows thus increasing the opening surface area ratio of the perforated holes 71b (diameter D2), enhancing solid filling in solid image printing, and achieving thus a required image density.

Specifically, the sub-scanning direction pitch is set to about 0.6 times to about 0.8 times the main scanning direction pitch. The sub-scanning direction pitch and the main scanning direction pitch for uncoated paper are determined beforehand and stored in a memory not shown in the figures.

The variable pitch control of the present embodiment and the master-making energy control for text/photograph separation in the first embodiment may also be carried out simultaneously.

A sixth embodiment of the present invention is explained next.

When in the present embodiment the paper type is recognized as “coated paper”, the temperature of the ink in the printing drum 10 of the printing apparatus is raised to lower ink viscosity, thus increasing the amount of ink passing through the perforated portions of the master during printing, and increasing the amount of ink transferred to the coated paper to be larger than in the case of uncoated paper, thereby enhancing solid image filling. The ink temperature for uncoated paper is determined beforehand and is stored in a memory not shown in the figures.

In conventional technology, a higher ink temperature in a stencil printing apparatus entails, to a certain extent, a larger amount of ink transferred to the printing paper.

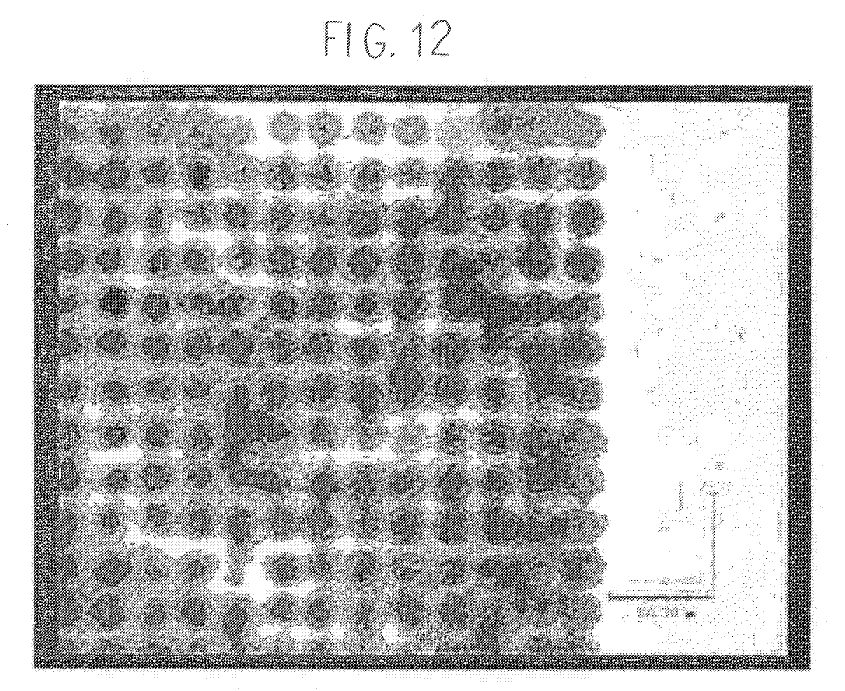

FIG. 11 illustrates an example of control flow by the control means 60 of a control system of the present embodiment.

The ink temperature control of the present embodiment and the master-making energy control for text/photograph separation in the first embodiment may also be carried out simultaneously.

The various embodiments above illustrate image forming and image fixing on coated paper, but the UV irradiation device 2 can be used in the same way for printing on uncoated paper. Since UV curable ink is more expensive than conventional emulsion ink, there may be concomitantly provided a printing drum for containing conventional emulsion ink, so that the printing drums are used separately for coated paper and uncoated paper; alternatively, the printing drum is replaced by a printing drum containing emulsion ink during printing on uncoated paper.

In these cases, the UV irradiation device 2 is removed during printing on uncoated paper, or remains installed but then the UV irradiation unit 31 is not operated, and only the printed product transport unit 32 is used.

The various embodiments above may involve also a coated paper-dedicated apparatus using only coated paper, in which case there is no need to provide paper type input means or paper type detection means. In such a case, moreover, the control means need not control the master-making energy and the like, and fixed values (experimentally determined values) corresponding to the characteristics of the coated paper may be set as the master-making conditions.

In the above embodiments, the UV irradiation device 2 is removably connected to the printing apparatus body 1, but may also be non-removably integrated with the printing apparatus body 1.

In the above embodiments, an UV irradiation device is provided as the ink curing device, so that ink is cured by UV rays. However, the embodiments are not limited thereto, and the ink used may be an ink that cures through heat, ultrasounds or the like, the ink curing device used being then a device corresponding to such an ink.

The present invention affords thus the following effects.

(1) Stencil printing becomes possible on coated paper, and hence the invention makes a contribution to the diversification of printing needs. That is, the invention allows solving the conventional problem according to which, during printing of solid images by stencil printing on coated paper, the density of solid image portions could not be ensured because the transferred ink remained in the form of spots that failed to spread. The invention enhances thus solid image filling and affords print images in which sufficient image density is ensured.

(2) In photograph images on coated paper, the invention allows obtaining a printed product having extremely high print quality by suppressing ink seeping and/or ink horizontal spreading on independent dots. In solid image portions and/or text image portions, the invention affords sufficient solid filling and hence ensures image density, while preventing problems such as fragmented text or the like.

(3) The invention has also a printing pressure control device, which uses a printing pressure varying mechanism of a printing pressure device, for controlling pressing force to so as to make it larger than the pressing force for uncoated paper. This allows solving the conventional problem according to which, during printing of solid images by stencil printing on coated paper, the density of solid image portions could not be ensured because the transferred ink remained in the form of spots that failed to spread. Through increased printing pressure during printing, and hence through increased ink transfer to the paper surface, the invention enhances solid image filling and affords print images for which sufficient image density is secured.

(4) By controlling the sub-scanning direction pitch so as to make it smaller than the main scanning direction pitch, the invention allows increasing the number of perforated holes per unit area on the master, thereby increasing the opening surface area ratio, enhancing as a result solid filling in solid image printing, and achieving thus the required image density.

(5) By making the power supply time to the heating elements of the thermal head longer than the power supply time for uncoated paper, and by controlling the master-making feeding speed in the master transport direction (thermal head sub-scanning direction) to make it smaller than the master-making feeding speed for uncoated paper, the invention allows preventing, for instance, the problem of perforated holes coming together on account of insufficient cooling time, or the problem of molten film clogging the holes or sticking to the thermal head, that occur when the power supply time to the heating elements of the thermal head is lengthened beyond a standard time with the purpose of increasing the diameter of the master-making perforated holes and increase thereby image density during printing. The invention prevents theses occurrences by lowering the master-making feeding speed, as compared with a standard feeding speed, thereby affording sufficient cooling time.

(6) The invention allows also enhancing solid image filling by increasing the ink temperature in the printing drum, thus lowering ink viscosity and increasing the amount of ink passing through the perforated portions of the master during printing, and making the amount of ink transferred to coated paper greater than that for uncoated paper.

(7) By increasing the thermal head supply energy during master-making, so as to enhance solid filling at solid image portions and/or text image portions in the print image, the perforated hole diameter becomes larger, and hence the invention allows obtaining images with sufficient solid filling, thus ensuring image density, as well as images where no fragmented text occurs. By carrying out master-making with standard energy on photograph image portions within the print image, thereby reducing seeping of individual dots during printing, the invention allows also obtaining a printed product having extremely high print quality by suppressing ink seeping and/or horizontal spreading on independent dots.

Various modifications will become possible for those skilled in the art after receiving the teachings of the present disclosure without departing from the scope thereof.

What is claimed is:

1. A stencil printing apparatus, comprising:
a master-making device for perforating a stencil master using master-making means;
a tubular printing drum around which the perforated stencil master is attached and which is rotationally driven;
a sheet feeding device for separating and feeding sheets for printing;
a printing pressure device for pressing a fed sheet against the outer peripheral face of said printing drum;
at least one among paper type input means for inputting a distinction of whether the sheets set in said sheet feeding device are coated paper or uncoated paper, and paper type detection means for detecting whether the sheets set in said sheet feeding device are coated paper or uncoated paper; and
control means for, when a fed sheet is recognized as coated paper, controlling a master-making energy supplied to said master-making means to be larger than that in the case of uncoated paper.

2. The stencil printing apparatus as claimed in claim 1, further comprising master-making mode input means capable of selecting and instructing at least a text mode and a photograph mode, as a master-making mode, wherein when a fed sheet is recognized as coated paper and a text mode is selected and instructed, said master-making means controls a master-making energy supplied to said master-making means to be larger than that for a photograph mode.

3. The stencil printing apparatus as claimed in claim 1, wherein said paper type detection means is configured to detect a paper type based on reflectance differences from the sheets.

4. A stencil printing apparatus, comprising:
a master-making device for perforating a stencil master using master-making means;
a tubular printing drum around which the perforated stencil master is attached and which is rotationally driven;
a sheet feeding device for separating and feeding sheets for printing;
a printing pressure device for pressing a fed sheet against the outer peripheral face of said printing drum;
at least one among paper type input means for inputting a distinction of whether the sheets set in said sheet feeding device are coated paper or uncoated paper, and paper type detection means for detecting whether the sheets set in said sheet feeding device are coated paper or uncoated paper;
a pressing force varying mechanism capable of varying a pressing force of said printing pressure device; and
control means for, when a fed sheet is recognized as coated paper, controlling the pressing force to be larger than that in the case of uncoated paper, using said pressing force varying mechanism.

5. The stencil printing apparatus as claimed in claim 4, wherein said paper type detection means is configured to detect a paper type based on reflectance differences from the sheets.

6. A stencil printing apparatus, comprising:
a master-making device for perforating a stencil master using master-making means;
a tubular printing drum around which the perforated stencil master is attached and which is rotationally driven;
a sheet feeding device for separating and feeding sheets for printing;
a printing pressure device for pressing a fed sheet against the outer peripheral face of said printing drum;
at least one among paper type input means for inputting a distinction of whether the sheets set in said sheet feeding device are coated paper or uncoated paper, and paper type detection means for detecting whether the sheets set in said sheet feeding device are coated paper or uncoated paper; and
control means for, when a fed sheet is recognized as coated paper, controlling a master-making feeding pitch in the transport direction of the stencil master in said master-making device, to be larger than that in the case of uncoated paper.

7. The stencil printing apparatus as claimed in claim 6, wherein when a fed sheet is recognized as coated paper, said master-making means controls a power supply time to each heating element of said master-making means to be larger than that in the case of uncoated paper, and controls a master-making feeding speed of the stencil master to be smaller than that in the case of uncoated paper.

8. The stencil printing apparatus as claimed in claim 6, wherein said paper type detection means is configured to detect a paper type based on reflectance differences from the sheets.

9. A stencil printing apparatus, comprising:
a master-making device for perforating a stencil master using master-making means;
a tubular printing drum around which the perforated stencil master is attached and which is rotationally driven;
an ink supply device for supplying ink to an inner face of the printing drum;
a sheet feeding device for separating and feeding sheets for printing;
a printing pressure device for pressing a fed sheet against the outer peripheral face of said printing drum;
at least one among paper type input means for inputting a distinction of whether the sheets set in said sheet feeding device are coated paper or uncoated paper, and paper type detection means for detecting whether the sheets set in said sheet feeding device are coated paper or uncoated paper;
ink heating means for heating ink of said ink supply device; and
control means for, when a fed sheet is recognized as coated paper, controlling the temperature of supplied ink to be larger than that in the case of uncoated paper using said ink heating means.

10. The stencil printing apparatus as claimed in claim 9, wherein said paper type detection means is configured to detect a paper type based on reflectance differences from the sheets.

11. A stencil printing apparatus, comprising:
a master-making device for perforating a stencil master using master-making means;
a tubular printing drum around which the perforated stencil master is attached and which is rotationally driven;
a sheet feeding device for separating and feeding sheets for printing;
a printing pressure device for pressing a fed sheet against the outer peripheral face of said printing drum;
at least one among paper type input means for inputting a distinction of whether the sheets set in said sheet feeding device are coated paper or uncoated paper, and paper type detection means for detecting whether the sheets set in said sheet feeding device are coated paper or uncoated paper;
text and photograph separation means for separating image information into a text image portion and a photograph image portion; and
control means for, when a fed sheet is recognized as coated paper, variably controlling an energy applied to each heating element of said master-making means such that a master-making perforated diameter of pixels constituting a text image portion is made larger than a master-making perforated diameter of pixels constituting a photograph image portion.

12. The stencil printing apparatus as claimed in claim 11, wherein said paper type detection means is configured to detect a paper type based on reflectance differences from the sheets.

13. A stencil printing apparatus, comprising:
a master-making device for perforating a stencil master using master-making means;
a tubular printing drum around which the perforated stencil master is attached and which is rotationally driven;
a sheet feeding device for separating and feeding sheets for printing;
a printing pressure device for pressing a fed sheet against the outer peripheral face of said printing drum; and
control means for, when said sheet is coated paper, controlling a master-making energy supplied to said master-making means to be larger than that in the case of uncoated paper for which master-making energy data is determined beforehand.

14. The stencil printing apparatus as claimed in claim 13, further comprising master-making mode input means capable of selecting and instructing at least a text mode and a photograph mode, as a master-making mode, wherein said master-making means controls a master-making energy supplied to said master-making means to be larger than that for a photograph mode.

15. A stencil printing apparatus, comprising:
a master-making device for perforating a stencil master using master-making means;
a tubular printing drum around which the perforated stencil master is attached and which is rotationally driven;
a sheet feeding device for separating and feeding sheets for printing;
a printing pressure device for pressing a fed sheet against the outer peripheral face of said printing drum;
a pressing force varying mechanism capable of varying a pressing force of said printing pressure device; and
control means for, when said sheet is coated paper, controlling the pressing force, using said pressing force varying mechanism, to be larger than that in the case of uncoated paper for which pressing force data is determined beforehand.

16. A stencil printing apparatus, comprising:
a master-making device for perforating a stencil master using master-making means;
a tubular printing drum around which the perforated stencil master is attached and which is rotationally driven;
a sheet feeding device for separating and feeding sheets for printing;
a printing pressure device for pressing a fed sheet against the outer peripheral face of said printing drum; and
control means for, when said sheet is coated paper, controlling a master-making feeding pitch in the transport direction of the stencil master in said master-making device, to be larger than that in the case of uncoated paper for which master-making feeding pitch data is determined beforehand.

17. The stencil printing apparatus as claimed in claim 16, wherein said master-making means controls a power supply time to each heating element of said master-making means to be larger than that for uncoated paper, and controls a master-making feeding speed of the stencil master to be smaller than that in the case of uncoated paper for which master-making feeding speed data is determined beforehand.

18. A stencil printing apparatus, comprising:
a master-making device for perforating a stencil master using master-making means;
a tubular printing drum around which the perforated stencil master is attached and which is rotationally driven;
an ink supply device for supplying ink to an inner face of the printing drum;
a sheet feeding device for separating and feeding coated paper as sheets for printing;
a printing pressure device for pressing a fed sheet against the outer peripheral face of said printing drum;
ink heating means for heating ink of said ink supply device; and
control means for controlling the temperature of supplied ink, using said ink heating means, to be larger than that in the case of uncoated paper for which temperature data for supplied ink is determined beforehand.

19. A stencil printing apparatus, comprising:
a master-making device for perforating a stencil master using master-making means;
a tubular printing drum around which the perforated stencil master is attached and which is rotationally driven;
a sheet feeding device for separating and feeding sheets for printing;
a printing pressure device for pressing coated paper as a fed sheet onto the outer peripheral face of said printing drum;
text and photograph separation means for separating image information into a text image portion and a photograph image portion; and
control means for variably controlling an energy applied to each heating element of said master-making means such that a master-making perforated diameter of pixels constituting a text image portion is made larger than a master-making perforated diameter of pixels constituting a photograph image portion.

20. A stencil printing apparatus, comprising:
a master-making device for perforating a stencil master using master-making means;
a tubular printing drum around which the perforated stencil master is attached and which is rotationally driven;
an ink supply device for supplying ink to an inner face of the printing drum;
a sheet feeding device for separating and feeding coated paper as sheets for printing;
a printing pressure device for pressing a fed sheet against the outer peripheral face of said printing drum;
ink heating means for heating ink of said ink supply device;
wherein at least one value among a master-making energy supplied to said master-making means, a pressing force by said printing pressure device, a master-making feeding pitch of the stencil master, a master-making feeding speed of the stencil master, and a supply ink temperature, is set to a value determined beforehand based on characteristics of uncoated paper.
